(19) United States
(12) Patent Application Publication
(10) Pub. No.: US 2020/0042058 A1
(43) Pub. Date: Feb. 6, 2020

(54) POWER COMMUNICATION DEVICE FOR DISPLAY CARD

(71) Applicant: EVGA CORPORATION, New Taipei City (TW)

(72) Inventor: Tai-Sheng Han, New Taipei City (TW)

(21) Appl. No.: 16/052,568

(22) Filed: Aug. 1, 2018

(51) Int. Cl. G06F 1/26; G06F 1/18; G09G 5/36

(52) U.S. Cl. CPC G06F 1/26; G06F 1/188; G06F 13/4068; G09G 2360/08; G09G 2330/021; G09G 5/363

(57) ABSTRACT

A power communication device for a display card includes a power supply, power processor configured on the power supply, display card configured at one side of the power supply, display card processor configured on the display card, transmission connector positioned between the power supply and display card, two ends of the transmission connector respectively in connection with the power supply and display card, at least one power passage, signal passage included inside the transmission connector, two ends of the power passage respectively in connection with the power supply and display card, and two ends of the signal passage the power processor and display processor. Whereby the power processor and display card processor can adjust the efficiencies of the power supply and display card, the overclocking use of the display card is more stable, and space can be saved because the signal passage is installed inside the power connector.

### (a) TECHNICAL FIELD OF THE INVENTION

The present invention relates to a power communication device for a display card, and more particularly to a power communication device for a display card allowing a display card to be more stable upon use, the cost to be saved, and the installation efficiency to be increased.

### (b) DESCRIPTION OF THE PRIOR ART

With the progress of the times, the ability of computers is getting more and more advanced, and with the upgrading of computers, the hardware specifications of the peripherals of the computer are naturally increasing. For example, the demand for power will also increase due to the level-up of display card or processor, causing the power processor's specifications to be also upgraded.

Most of the display cards built in motherboards today are not enough to support current software and 3D technologies, and There are even many motherboards that don't have a built-in display card at all such that they will be in connection with an external display card for use. Furthermore, modern display cards with better efficiency can then have enough power to be driven only in connection with an additional power supply so that a plug of 6 pins or 8 pins will be also used for most display cards to be in connection with a power supply.

However, a matching power supply will be needed to change the supplied power when a display card needs to be overclocked so that some people will install an extra microprocessor for control in connection with the power supply and display card. But, space will be wasted, the installment is also troublesome, and the control efficiency is not stable enough when having only one external processer.

### SUMMARY OF THE INVENTION

To increase display card processor efficiency and occupy less space, the present invention is proposed.

The main object of the present invention is to provide a power communication device for a display card, using a power processor to be operated in coordination with a display card processor to allow the operation of the display card to be more stable, and installing a signal passage connecting the power processor to the display card processor inside a transmission connector in connection with a power supply so as to save space and have a convenient installment.

To achieve the object mentioned above, the present invention proposes a power communication device for a display card, including a power supply, power processor configured on the power supply, display card configured at one side of the power supply, display card processor configured on the display card, transmission connector positioned between the power supply and display card, two ends of the transmission connector respectively in connection with the power supply and display card, at least one power passage and at least one signal passage included inside the transmission connector, two ends of the power passage respectively in connection with the power supply and display card, and two ends of the signal passage the power processor and display processor.

With the above structure, the power passage can transmit power from the power supply to display card. Upon the operation of the display card, the use power of the display card can be controlled and adjusted with the display card processor, and the power processor can then control and adjust the output power of the power supply. Furthermore, the display card processor and power processor can be in connection with each other through the signal passage, thereby in communication with each other and adjusting the operation statuses of the display card and power supply, allowing the operation and overclocking use of the display card to be more stable.

Because the signal passage connecting the power processor to display card processor is positioned inside the transmission connector for power transmission, it is unnecessary to add an extra wire to do the connection, and space can then be saved and the installment will also be effective because only one line of communication is needed.

### BRIEF DESCRIPTION OF THE DRAWINGS

FIG. 1 is a perspective view of a preferred embodiment of the present invention;

FIG. 2 is a structural block diagram of the embodiment of the present invention;

FIG. 3 is a perspective view of another preferred embodiment of the present invention;

FIG. 4 is a structural block diagram of another embodiment of the present invention; and

FIG. 5 is a schematically perspective view of the connection of another embodiment of the present invention.

### DETAILED DESCRIPTION OF THE PREFERRED EMBODIMENTS

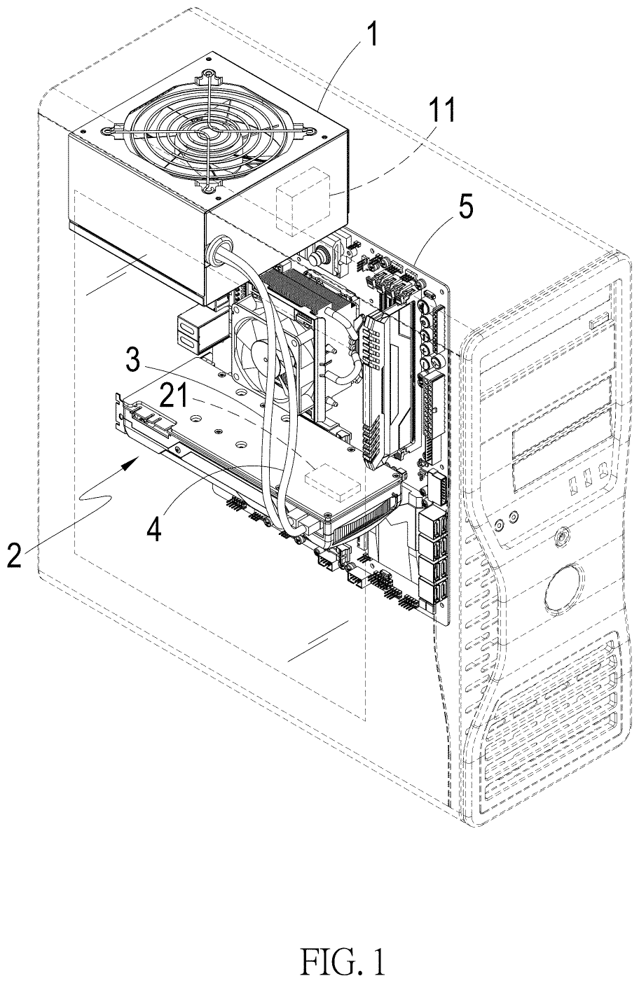

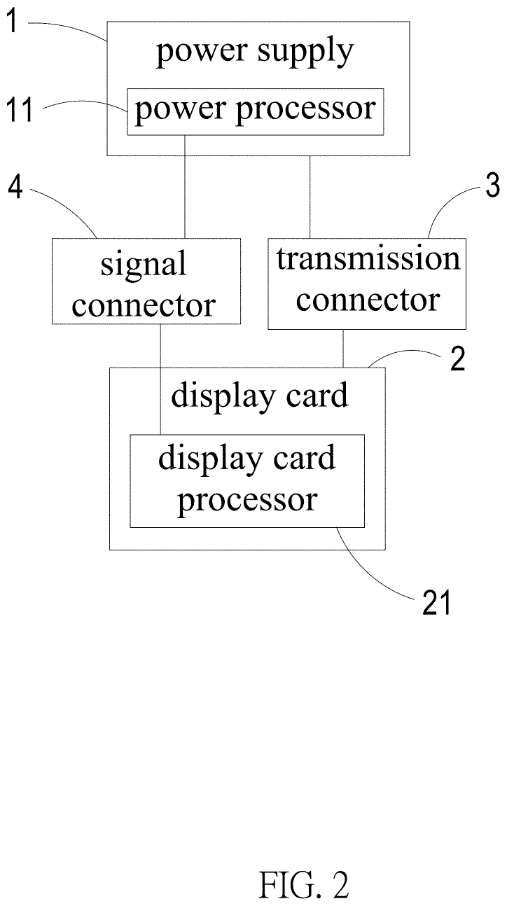

Referring to FIGS. 1 and 2, a power communication device for a display card of the present invention, in a preferred embodiment, includes: a power supply 1, power processor 11, display card 2, display card processor 21, transmission connector 3 and signal connector 4, where the power processor 11 is configured on the power supply 1, the display card processor 21 the display card 2, where the power processor 11 and display card processor 21 respectively are a microprocessor (MCU). Furthermore, the transmission connector 3 is positioned between the display card 2 and power supply 1, and the two ends thereof are respectively in connection with the display card 2 and power supply 1, and the signal connector 4 is also positioned between the display card 2 and power supply 1, and the two ends thereof are respectively in connection with the display card processor 21 and power processor 11. With the above description, it is understood that the power processor 11 is used to operate in coordination with the display card processor 21 to control and adjust the power supply 1 and display card 2 according to the corresponding match of this structure, allowing the operation of the display card 2 to be more smooth and stable, and the details will be explained as the following.

With the construction of the above components, it can be seen clearly from the figures that the power processor 11 and display card 2 may be inserted in a motherboard 5, and the power processor 11 can control and adjust the output power of the power supply 1 and the power is transmitted to the display card 2 through the transmission connector 3. Furthermore, the display card processor 21 can control and adjust the use power of the display card 2 upon operation; the power processor 11 and display card processor 21 will be in signal connection with each other through the signal connector 4, thereby in communication with each other. When the display card 2 is overclocked, the operation statuses of the display card 2, for example, the rotating speed adjustment of a fan, the frame change rate of the picture, and etc., can be adjusted with the display card processor 21, and the power supply efficiency of the power supply 1 can be adjusted with the power processor 11 at the same time when being notified, thereby matching the operation efficiency of the display card 2 so as to allow the operation and overclocking use of the display card 2 to be more stable. Therefore, the present invention is far more stable and effective than the adjustment and control of a single external processor because the power processor 11 is used to match the display card processor 21 to do the adjustment and control at the same time.

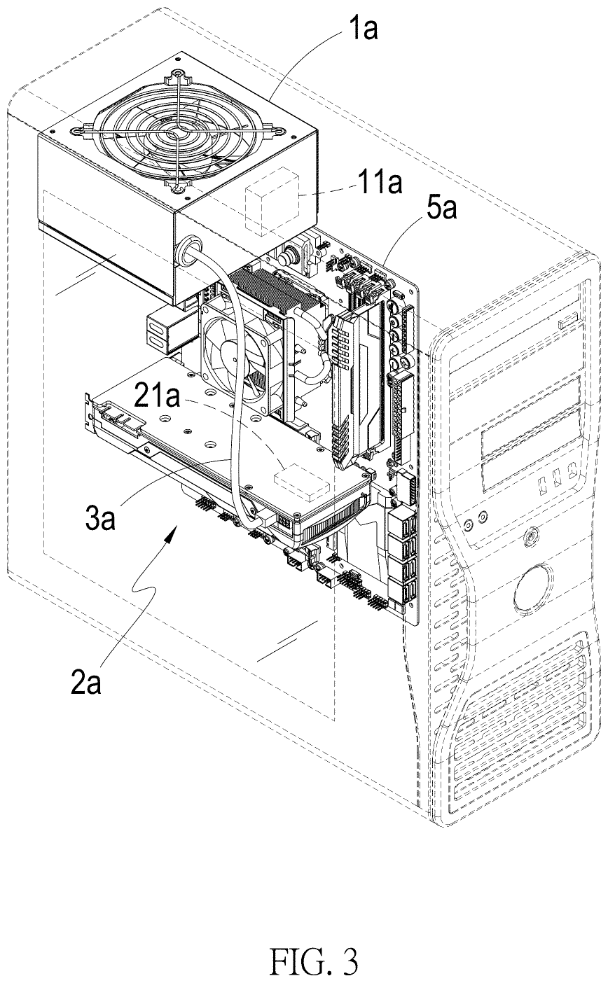

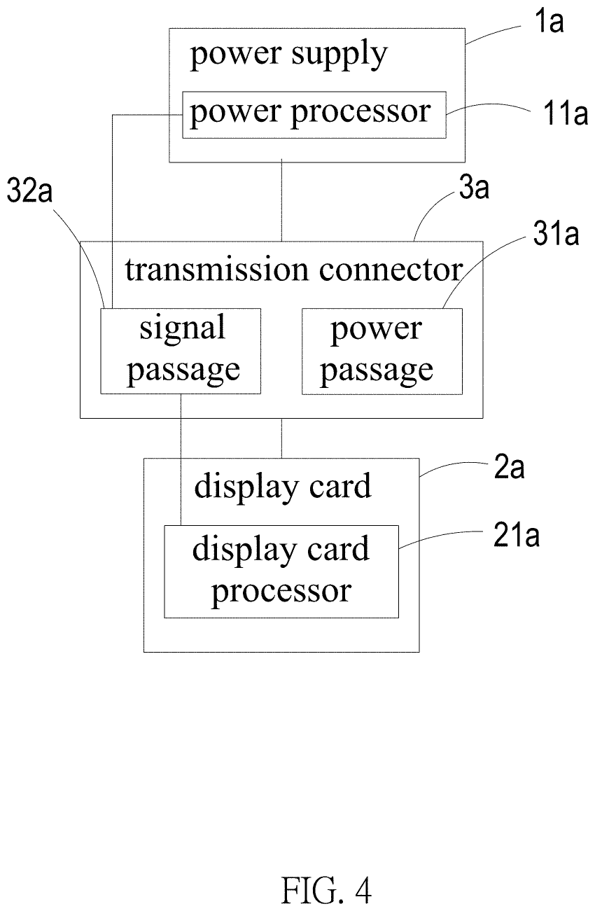

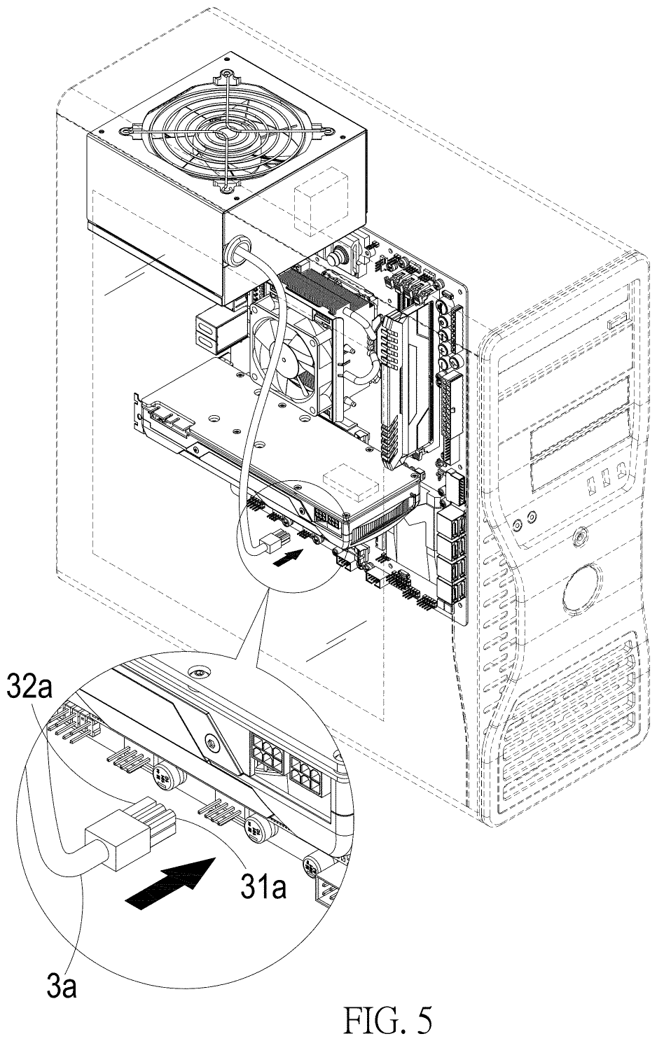

Referring to FIGS. 3 to 5, showing another preferred embodiment of a power communication device for a display card of the present invention, the present embodiment is almost similar to the above embodiment except at least one power passage 31a and at least one signal passage 32a is included inside a communication connector 3a in the present embodiment. When a power supply 1a and display card 2a are inserted in a motherboard 5a for use, the power supply 1a is in connection with the display card 2a only through the transmission connector 3a, and the power passage 31a will so connect the power supply 1a to the display card 2a, thereby allowing the power supply 1a to transmit power to the display card 2a. furthermore, the signal passage 32a will connect the power processor 11a to the display card processor 21a, allowing the power processor 11a and display card processor 21a to be in connection and communication with each other through the signal passage 32a; because the signal passage 32a is configured inside the transmission connector 3a originally used to transmit power. For example, the signal passage 32a is installed in the empty position in the 6-pin connection head, or the original 6-pin connection head is changed to an 8-pin connection head to widen the signal passage 32a, but the present invention is not so limited. Therefore, the present invention does not need an extra connecting wire, and the effect of saving space and cost can then be achieved. In addition, only the transmission connector 3a is enough upon installment, and the installment manner thereof is quicker and simpler.

Therefore, the present invention has the following advantages over the prior arts:
1. the display card processor 21 operated in coordination with the power processor 11 is used to control and adjust the display card 2 and power supply 1, allowing the display card 2 to be operated more stable; and
2. the power passage 31a and signal passage 32a are configured inside the transmission connector 3a so that only one transmission connector 3a can achieve the effects of signal transmission and power transmission, thereby saving space and cost and having a convenient installment effect.

1. A power communication device for a display card, comprising:
a power supply;
a power processor, configured on said power supply, and adapted to control and adjust a status of said power supply;
a display card, configured at one side of said power supply;
a display card processor, configured on said display card, and adapted to control and adjust a status of said display card, said display processor in signal connection with said power processor, allowing said power processor and display card processor to be operated in coordination with each other so as to promote the operation stability of said display card; and
a transmission connector, configured between said display card and power supply, and two ends thereof respectively in connection with said power supply and display card.

2. The device according to claim 1, wherein said power supply and display card are in connection with a motherboard.

3. The device according to claim 1, wherein said power processor and display card processor are in signal connection with each other through a signal connector.

4. A power communication device for a display card, comprising:
a power supply;
a power processor, configured on said power supply, and adapted to control and adjust a status of said power supply;
a display card, configured at one side of said power supply;
a display card processor, configured on said display card, and adapted to control and adjust a status of said display card, said display card in signal connection with said power processor, allowing said power processor and display card processor to be operated in coordination with each other so as to promoting the operation stability of said display card; and
a transmission connector, positioned between said display card and power supply, two ends of said transmission connector respectively in connection with said power supply and display card, at least one power passage and at least one signal passage included inside said transmission connector, two ends of said power passage respectively in connection with said power supply and display card and adapted to transmit power signals from said power supply to said display card, said signal passage positioned at one side of said power passage, two end thereof respectively in connection with said power supply and display processor, allowing said display card processor and power processor to be in signal connection with each other.

5. The device according to claim 4, wherein said power supply and display card are in connection with a mother board.

6. The device according to claim 4, wherein said signal passage is configured inside said transmission connector by means of increasing pins or adjusting pins.
